(19) United States
(12) Patent Application Publication
(10) Pub. No.: US 2014/0150667 A1
(43) Pub. Date: Jun. 5, 2014

(54) BREWING DEVICE AND BREWING MACHINE HAVING THE BREWING DEVICE

(71) Applicant: ACCVAL L.L.C, DOVER, DE (US)

(72) Inventor: Chen-Jui Liao, Dover, DE (US)

(73) Assignee: ACCVAL L.L.C, Dover, DE (US)

(21) Appl. No.: 13/887,089

(22) Filed: May 3, 2013

(30) Foreign Application Priority Data
Nov. 30, 2012 (TW) 101223250

(51) Int. Cl. A47J 31/44

(52) U.S. Cl. CPC A47J 31/446
USPC 99/323

(57) ABSTRACT

A brewing device includes a supporting ring having a ring body adapted to be disposed on an inner surface of a container, and an inner magnetic member fixed in the ring body. A filter is disposed on and supported by the ring body and is movable along with the ring body. An operator includes an operator body adapted to be disposed on an outer surface of the container and is adapted to be movable relative to the container, and an outer magnetic member fixed in the operator body and magnetically engaging the inner magnetic member. The operator is operable to move the supporting ring and the filter upwardly and downwardly relative to the container.

### CROSS-REFERENCE TO RELATED APPLICATION

This application claims priority of Taiwanese Patent Application No. 101223250, filed on Nov. 30, 2012.

### BACKGROUND OF THE INVENTION

1. Field of the Invention

The invention relates to a brewing device, more particularly to a brewing device that can brew a brewable material at various liquid levels and that can permit the brewable material to move away from a liquid surface after brewing, and a brewing machine having the brewing device.

2. Description of the Related Art

When using a conventional brewing utensil, tea leaves are first placed in a filter on a cup, followed by pouring hot water into the cup until the tea leaves are immersed in the hot water. At an optimal brewing time, the filter containing the tea leaves is removed from the cup to avoid continuous immersion of the tea leaves in the hot water and excessive brewing. Consequently, a place for placing the filter must be found, thereby causing inconvenience. In addition, such brewing method requires a fixed amount of water. If the amount of water is reduced, the tea leaves will not be immersed in the water, and therefore the brewing process cannot be carried out.

### SUMMARY OF THE INVENTION

Therefore, an object of the present invention is to provide a brewing device that can brew a brewable material at various liquid levels and that can permit the brewable material to move away from a liquid surface after brewing.

Another object of the present invention is to provide a brewing machine having a brewing device that can brew a brewable material at various liquid levels and that can permit the brewable material to move away from a liquid surface after brewing.

According to one aspect of the present invention, a brewing device for engaging a container and for brewing a brewable material comprises a supporting ring , a filter and an operator.

The supporting ring includes a ring body adapted to be disposed movably on an inner surface of the container, and an inner magnetic member fixed in the ring body.

The filter is disposed on and supported by the ring body and is movable along with the ring body.

The operator includes an operator body and an outer magnetic member. The operator body is adapted to be disposed on an outer surface of the container and is adapted to be movable upwardly and downwardly relative to the container. The outer magnetic member is fixed in the operator body and magnetically engages the inner magnetic member. The operator is operable to move the supporting ring and the filter upwardly and downwardly relative to the container.

According to another aspect of the present invention, a brewing machine for brewing a brewable material comprises a container and a brewing device.

The brewing device includes a supporting ring, a filter and an operator. The supporting ring includes a ring body disposed movably on an inner surface of the container, and an inner magnetic member fixed in the ring body.

The filter is disposed on and supported by the ring body and is movable along with the ring body.

The operator includes an operator body and an outer magnetic member. The operator body is disposed on an outer surface of the container and is movable upwardly and downwardly relative to the container. The outer magnetic member is fixed in the operator body and magnetically engages the inner magnetic member. The operator is operable to move the supporting ring and the filter upwardly and downwardly relative to the container.

### BRIEF DESCRIPTION OF THE DRAWINGS

Other features and advantages of the present invention will become apparent in the following detailed description of the preferred embodiments with reference to the accompanying drawings, of which:

FIG. 1 is a sectional top view of a brewing machine according to the first preferred embodiment of the present invention;

FIG. 2 is a sectional side view of the first preferred embodiment taken along line II-II of FIG. 1;

FIG. 3 is a view similar to FIG. 2, but illustrating a filter being moved away from a liquid surface;

FIG. 4 is a view similar to FIG. 2, but illustrating a brewing machine according to the second preferred embodiment of the present invention;

FIG. 5 is a sectional top view of a brewing machine according to the third preferred embodiment of the present invention; and

FIG. 6 is a sectional side view of the third preferred embodiment taken along line VI-VI of FIG. 5.

### DETAILED DESCRIPTION OF THE PREFERRED EMBODIMENTS

Before the present invention is described in greater detail, it should be noted that like elements are denoted by the same reference numerals throughout the disclosure.

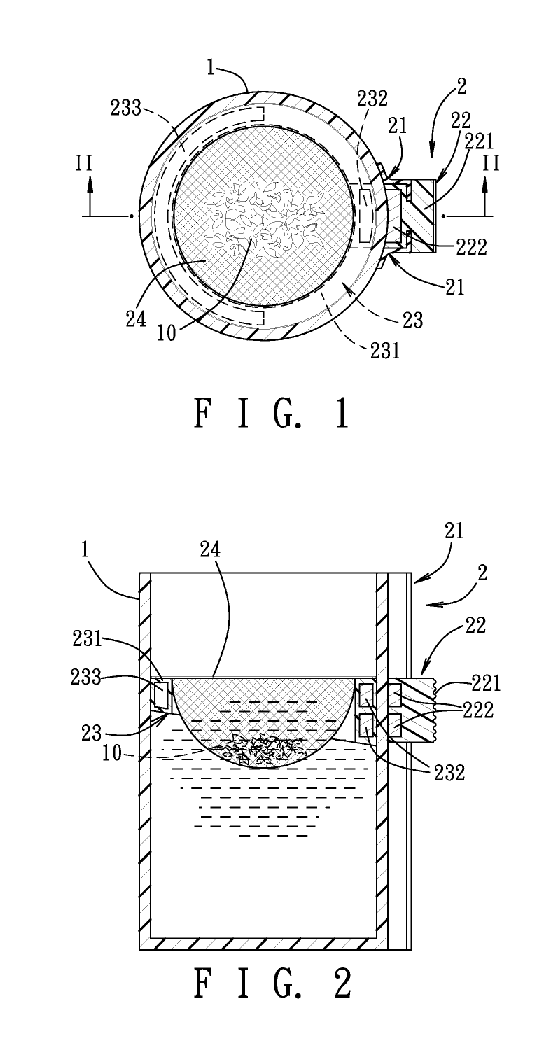

Referring to FIGS. 1 to 3, a brewing machine according to the first preferred embodiment of the present invention is used for brewing a brewable material 10, and comprises a container 1 and a brewing device 2. In this embodiment, the brewable material 10 is exemplified as tea leaves, but is not limited thereto. The brewable material 10 may be dried flowers, fruits, coffee, etc.

The brewing device 2 includes two slide rails 21, an operator 22, a supporting ring 23 and a filter 24.

The slide rails 21 are fixed to an outer surface of the container 1 and extend along the length of the container 1. In this embodiment, each of the slide rails 21 has a substantially Z-shaped cross section. The operator 22 includes an operator body 221 and two outer magnetic members 222. The operator body 221 is disposed on the outer surface of the container 1, and is engaged to and slidable upward and downward along and between the two slide rails 21. The outer magnetic members 222 are fixed in the operator body 221.

The supporting ring 23 includes a ring body 231 and two inner magnetic members 232. The ring body 231 is disposed on and movable upward and downward relative to an inner surface of the container 1 . The inner magnetic members 232 are fixed in the ring body 231 and correspond in position to the outer magnetic members 222. Each of the outer magnetic members 222 magnetically engages a respective inner magnetic member 232.

When the outer and inner magnetic members 222, 232 are magnetically engaged to each other, a user can push the operator 22 to move upwardly and downwardly relative to the container 1 so as to simultaneously move therealong the supporting ring 23. Further, through the magnetic attraction between the outer and inner magnetic members 222, 232, the operator 22 and the supporting ring 23 can abut tightly against the respective outer and inner surfaces of the container 1 and produce sufficient friction to maintain a height thereof and will not slide down from the container 1.

The filter 24 is disposed on and supported by the ring body 231, and is movable along with the ring body 231. In this embodiment, the filter 24 is hemispherical, but may be spherical or other shapes that match the shape of the container 1. As long as the filter 24 can hold the brewable material 10 and can move along with the ring body 231 upwardly and downwardly in the container 1, any simple equivalent modifications thereof belongs to the scope of the present invention.

In this embodiment, the ring body 231 of the supporting ring 23 has a thickness that gradually decreases from a side that is proximate to the operator 22 to another side that is distal from the operator 22 so as to reduce the volume thereof . As such, the force required to move the ring body 231 inside the container 1 during operation of the operator 22 can be effectively reduced.

Further, the ring body 231 is formed with an airtight space 233. The airtight space 233 can effectively reduce the weight of the ring body 231. Hence, the force required to move the ring body 231 inside the container 1 can be further reduced. Moreover, if the inner magnetic members 232 are magnetically disengaged from the outer magnetic members 222, the supporting ring 23 will drop and float on a liquid surface, so that the inner magnetic members 232 can be easily and magnetically attracted again by the outer magnetic members 222. Hence, the supporting ring 23 and the brewable material 10 can be prevented from being submerged in the liquid.

In this embodiment, the outer and inner magnetic members 222, 232 are magnets, but are not limited thereto. Alternatively, each outer magnetic member 222 may be a magnet, whereas each inner magnetic member 232 may be made of a magnetically attractive material, such as iron, cobalt, nickel, or other alloys. As long as the outer and inner magnetic members 222, 232 can be magnetically attracted to each other, can allow the operator 22 and the supporting ring 23 to provide a sufficient friction against the container 1 so as to stably maintain a height thereof, and that can hold the filter 24, any simple equivalent modifications thereof belongs to the scope of the present invention.

With reference to FIG. 2, in use, the brewable material 10 is first placed in the filter 24, after which the operator 22 is moved downward together with the supporting ring 23 until the filter 24 is moved into water contained in the container 1, thereby allowing the brewable material 10 to be soaked in the water.

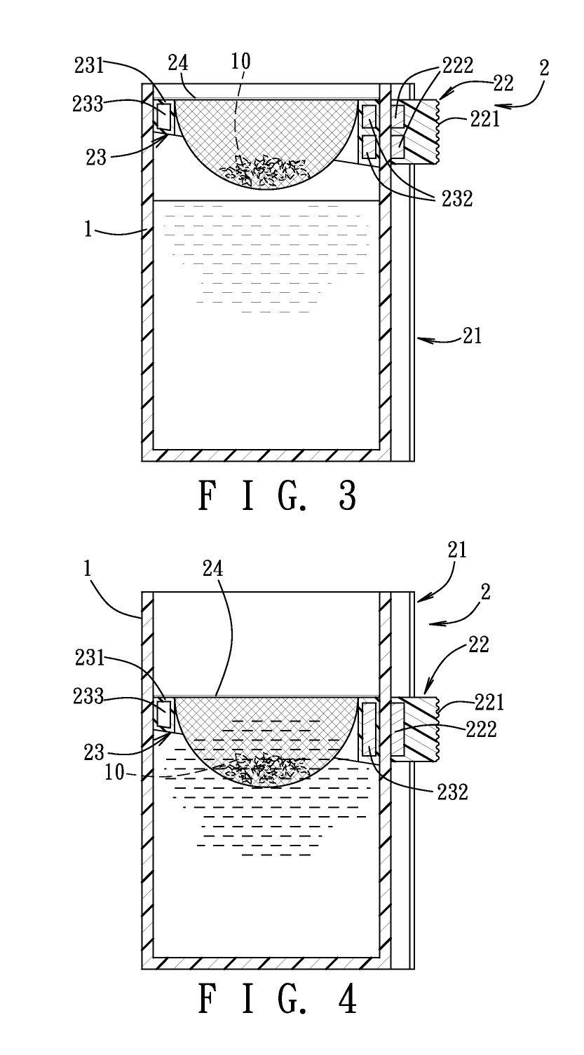

With reference to FIG. 3, if the user wishes to remove the brewable material 10 from the water after a brewing time has s passed, the operator 22 is moved upward together with the supporting ring 23 until a position shown in FIG. 3 is reached. In this position, the brewable material 10 is moved out of the liquid surface, and the brewing is completed.

It is worth mentioning that although the number of each of the outer and inner magnetic members 222, 232 in this embodiment is two, it is not limited thereto. The number of the outer magnetic member 222 may be numerous, and the inner magnetic member 232 may correspond in number to the outer magnetic member 222.

Further, when the amount of water in the container 1 is less, the operator 22 together with the supporting ring 23 is moved downward to place the brewable material 10 in water. Because the supporting ring 23 and the filter 24 can be positioned at any height, brewing of the brewable material 10 at different levels of water may be accomplished.

Referring to FIG. 4, a brewing machine according to the second preferred embodiment of the present invention is shown to be similar in structure to the first preferred embodiment. However, in this embodiment, the operator 22 includes one outer magnetic member 222, and the supporting ring includes one inner magnetic member 232 corresponding in position to the outer magnetic member 222.

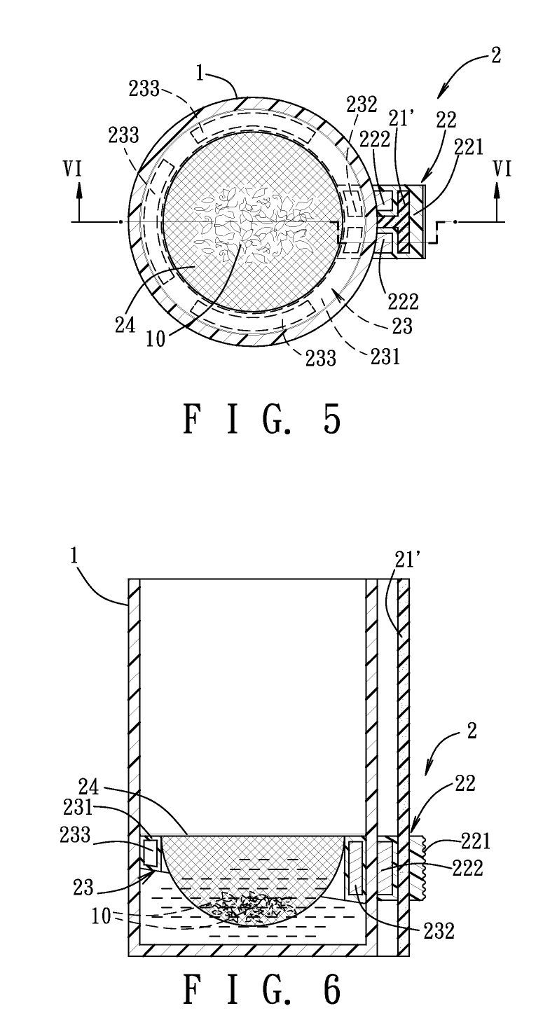

Referring to FIGS. 5 and 6, a brewing machine according to the third preferred embodiment of the present invention is shown to be similar in structure to the first preferred embodiment. However, in this embodiment, the brewing device 2 includes only one slide rail 21′ that is fixed to the outer surface of the container 1 and that extends along the length of the container 1. In this embodiment, the slide rail 21′ has a substantially T-shaped cross-section. The operator body 221 of the operator 22 is engaged to the slide rail 21′ such that the operator 22 is upwardly and downwardly movable along the extending direction of the slide rail 21′.

It is worth mentioning that in this third preferred embodiment, the ring body 231 of the supporting ring 23 is formed with three angularly spaced-apart airtight spaces 233, but is not limited thereto.

The method of use is similar to that described in the first preferred embodiment.

In summary, through the provision of the outer and inner magnetic members 222, 232, the operator 22 can drive the supporting ring 23 to move upwardly and downwardly relative to the container 1 through magnetic attraction between the outer and inner magnetic members 222, 232, thereby positioning the filter 24 to a desired height. Therefore, the object of this invention is served.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A brewing device for engaging a container and for brewing a brewable material, said brewing device comprising:
a supporting ring including a ring body adapted to be disposed movably on an inner surface of the container, and an inner magnetic member fixed in said ring body;
a filter disposed on and supported by said ring body and movable along with said ring body; and
an operator including an operator body that is adapted to be disposed on an outer surface of the container and that is adapted to be movable upwardly and downwardly relative to the container, and an outer magnetic member fixed in said operator body and magnetically engaging said inner magnetic member, said operator being operable to move said supporting ring and said filter upwardly and downwardly relative to the container. 20

2. The brewing device as claimed in claim 1, further comprising a slide rail that is adapted to be fixed to the outer surface of the container and that is adapted to extend along the length of the container, said operator body being slidably engaged with said slide rail.

3. The brewing device as claimed in claim 1, wherein said ring body has a thickness that gradually decreases from a side that is proximate to said operator to another side that is distal from said operator.

4. The brewing device as claimed in claim 1, wherein said ring body is formed with at least one airtight space.

5. A brewing machine for brewing a brew-able material, comprising:
a container; and
a brewing device including
a supporting ring including a ring body disposed movably on an inner surface of said container, and an inner magnetic member fixed in said ring body,
a filter disposed on and supported by said ring body and movable along with said ring body; and
an operator including an operator body that is disposed on an outer surface of said container and that is movable upwardly and downwardly relative to said container, and an outer magnetic member fixed in said operator body and magnetically engaging said inner magnetic member, said operator being operable to move said supporting ring and said filter upwardly and downwardly relative to said container.

6. The brewing machine as claimed in claim 5, wherein said brewing device further includes a slide rail that is fixed to said outer surface of said container and that extends along the length of said container, said operator body being slidably engaged with said slide rail.

7. The brewing machine as claimed in claim 5, wherein said ring body has a thickness that gradually decreases from a side that is proximate to said operator to another side that is distal from said operator.

8. The brewing machine as claimed in claim 5, wherein said ring body is formed with at least one airtight space.
